(19) United States
(12) Patent Application Publication
(10) Pub. No.: US 2002/0111915 A1
(43) Pub. Date: Aug. 15, 2002

(54) Payment management

(76) Inventors: Christopher Donald Clemens, Minneapolis, MN (US); Mark S. Coronna, Vadnais Heights, MN (US); Mark Robert O'Leary, St. Paul, MN (US)

Correspondence Address: JOHN A. DRAGSETH, Fish & Richardson P.C., P.A., Suite 3300, 60 South Sixth Street, Minneapolis, MN, 55402, US

(21) Appl. No.: 09/781,579

(22) Filed: Feb. 12, 2001

(51) Int. Cl. G06F 17/60; H04K 1/00; H04L 9/00

(52) U.S. Cl. 705/64; 705/39

(57) ABSTRACT

A method and system of effecting a payment from a payor in response to a payment request, comprising selecting a payment method from a set of payment methods. The payment method may be independent of a payment method selected for a payee. The payment may be effected by transmitting a message comprising a get funds trigger, a get funds type, a send funds trigger, and a send funds type, corresponding to the payment transaction. A method and system may receive a plurality of payment transaction notices, calculating a net account status value based on the plurality of transaction notice, and executing payment of the net account status value.

### TECHNICAL FIELD

The invention relates to a payment processing and management system.

### BACKGROUND

A number of payment options are available to a payor who wishes to settle with a payee for purchased goods or services. Originally, payments were made through the barter of goods, but in time, cash payment developed to make it easier for two people to conduct a transaction where one person did not have any goods that the other person wanted. Cash had an advantage over barter in that cash is largely fungible, so that buyers and sellers did not have to find a perfect match of goods demanded and goods offered.

Later, buyers began using printed paper checks that they delivered to the payee. Although checks may be written for any specific amount up to the amount available in the account, checks have very limited transferability and must be supplied from a physical inventory. Paper-based checking systems do not offer sufficient relief from the limitations of cash transactions. In addition, a payor that wants to pay by check must find a payee who is willing to receive payment by check. Overall, checks share many of the inconveniences of handling currency and add the inherent delays associated with processing checks. To this end, economic exchange has striven for greater convenience at a lower cost, while also seeking improved security.

Automation has overcome some of the disadvantages of older payment systems. For example, transactions may be settled through computerized electronic funds transfer (“EFT”) systems. Electronic funds transfer is essentially a process of value exchange achieved through the banking industry's centralized computer systems. EFT services are a transfer of payments utilizing electronic “checks,” which are used primarily by large commercial organizations. Examples of EFT systems that are used by retail and commercial organizations are the Automated Clearing House (“ACH”), by which automated credits and debits may be made to a user's account. Alternatively, Point Of Sale (“POS”) systems, such as common credit card systems, may connect from a remote store to a central computer for immediate authorization or denial of a transaction.

However, the payments made through these types of systems are limited. In performing a payment operation, EFT systems generally transmit a minimal amount of information with the payment. As a result, users of the system must generally establish themselves with the system before a transaction, and also must generally define their relationships with their payment partners. The types of payments that may be made by EFT systems are also limited. Likewise, POS systems are also limited. The systems are generally proprietary and only permit a limited number of payment options, for example by credit card. In addition, although such system are relatively inexpensive on a per-transaction basis, they can become very expensive if used to clear a very large number of transactions.

Nor do such systems adequately solve these problems when they are used in conjunction with on-line transactions. Rather, the resulting products are generally just implementations of existing off-line systems adapted to work on-line. They do not provide a payor and a payee with adequate flexibility or information so that they may structure their transaction in a manner that is easy to use and that optimizes the options available to the payor and to the payee. If the payor and payee cannot agree on the precise parameters of payment, the transaction may be impossible to complete. Furthermore, although the systems may substantially lower the cost of transferring payments, they do not adequately permit the payor and payee to reduce their internal costs of preparing for and receiving payment. These internal costs, such as setting the terms for a transaction, approving payment, invoicing, tracking shipments, and reconciling, all must generally take place apart from the payment process itself, and are generally a large share of the total transaction cost. As a result, many payments are still carried out by check, even when the related transaction is performed electronically. Thus, there is a need for a system that provides intelligence and flexibility to the payment process.

### SUMMARY OF THE INVENTION

In general, the invention is directed to a system and method for effecting payment from a payor to a payee, whereby the payment method for either the payor or the payee, or for both the payor and the payee, may be selected based on factors that indicate the payment preferences for the payor or payee. The payment method selected for the payor may differ from that selected for the payee, so that the system may standardize and match payment information across disparate payment vehicles. The system may provide for an information structure that attaches additional data to the data needed to carry out a simple payment transaction. As a result, the system and method may achieve functionality that cannot be achieved without the presence of the additional data. For example, the system and method may consolidate all order data from different payment vehicles into a single report for review and reconciliation. The system may also recommend payment methods to a payor or payee, may provide reconciliation services for payor or payee, and may permit the payor or payee to specify particular parameters for payment. In addition, the system may aggregate payment transactions and provide for inter-organization settlement of payments.

In one configuration, the invention is directed to a computer processor implemented method of effecting a payment intended for a payee from a payor, whereby a payment request is received indicating that the payor has authorized payment to the payee. The method may configure a payment transaction by selecting a payment method for the payor from a first set of payment methods using a payment rule, wherein the selected payment method is independent of a payment method selected for the payee, and may execute the payment request to cause a first payment to be made from the payor and a second payment to be made to the payee. The payment rule may be a predetermined business rule, may be a function of pre-negotiated terms between the payor and the payee, and may select a payment method according to the amount of the payment, as a function of historical payment information, or as a function of previous transactions between the payor and the payee, or between the payor or payee and other parties. The method may also verify the authorization of the payment request by seeking payment approval, for example, by communicating payment information to one or more agents of the payor, either in parallel or serially. The method may also provide for the enrollment the payor by receiving payor identifying and enrollment information, such as names and account numbers, and may verify the ability of the payor to make payments, for example, using an independent credit rating service. The method may also provide for the reporting of payment status, for example, by aggregating information regarding the status of a plurality of payment transactions. The method may also schedule a payment according to a particular triggering event, such as an event generated by an exchange of goods or service, the occurrence of a set time, or the payor's current account status, and the timing of the payment from the payor may be different than that to the payee.

In another configuration, the invention is directed to a computer processor implemented method of effecting a payment to a payee, whereby a payment request is received indicating that the payor has authorized payment to the payee. The method may configure a payment transaction by selecting a payment method for the payee from a first set of payment methods using a payment rule, wherein the selected payment method is independent of a payment method selected for the payor, and may execute the payment request to cause a first payment to be made from the payor and a second payment to be made to the payee. The payment rule may be a predetermined business rule, may be a function of pre-negotiated terms between the payor and the payee, and may select a payment method according to the amount of the payment, as a function of historical payment information, or as a function of previous transactions between the payor and the payee, or between the payor or payee and other parties. The method may also provide for the enrollment of the payee by receiving payee identifying and enrollment information, such as names and account numbers, and may also provide for the reporting of payment status, for example, by aggregating information regarding the status of a plurality of payment transactions. The method may also schedule a payment according to a particular triggering event, such as an event generated by an exchange of goods or service, the occurrence of a set time, or the payee's current account status, and the timing of the payment from the payor may be different than that to the payee.

In yet another configuration, the invention is directed to a computer processor implemented method of effecting a payment from a payor to a payee, whereby a payment request is received, a first payment method is selected for the payor from a first set of payment methods, a second payment method is selected for the payee from a second set of payment methods, the payment request is executed to cause a first payment to be made from the payor and a second payment to be made to the payee, where the first payment method is selected independently of the second payment method. The payment methods may be selected by business rules, for example, as a function of the payment amount, pre-negotiated business terms, or past transaction information between the payor and the payee, or between the payor or payee and a third party. The status of a plurality of payments may also be reported to the payor or the payee, and payments may be executed in response to triggering events, such as events that are the function of the payor's current account position or the delivery status of an item associated with the payment request. The triggering event for the payor may be different than the triggering event for the payee.

In another configuration, a system for effecting payment from a payor may comprise a database of payor information, a request interface that receives a payment request containing payment information, a payment selector programmed to configure a payment transaction by selecting a payment method from a first set of payment methods as a function of the payor information and the payment request, and a payment processor that executes payment by the selected payment method. The database may comprises payment selection rules, and the payment selector may apply a predetermined function to the payment information and compare the result of the function to a predetermined result, for example, by comparing the monetary value of the payment to an array of monetary values. The payment selector may select the payment method independently of a payment method selected for the payee, and may select the payment method from a predetermined set of payment methods. The system may also comprise payment approval verifier that determines whether the payment authorization request is valid and seeks payment approval if the payment authorization request is invalid

In yet another configuration, a computer-readable medium is disclosed having instructions contained therein to cause a programmable processor to receive a payment authorization indicating that the payor has authorized payment, to select a payment method for the payor from one of a first set of payment methods, and execute the payment request to cause the payment to be made from the payor, and wherein the selected payment method is independent of a payment method selected for the payee.

A method of executing a payment transaction from a payor to a payee is also disclosed, and comprises receiving a payment authorization request, creating a get funds trigger that carries information for selecting a method of making payment, creating a get funds type that carries information for selecting a method of receiving payment, creating an approval that carries information for determining the approval status of the payment, creating a send funds trigger that carries information for executing a transmittal of funds, creating a send funds type that carries information for selecting a method of receiving payment, transmitting the get funds trigger, get funds type, approval, send funds trigger, and send funds type in a single message, executing payment from the payor using a payment method corresponding to the get funds type, and executing payment to the payee using a payment method corresponding to the send funds type. A value may also be assigned to at least one of the get funds trigger, the get funds type, the send funds trigger, or the send funds type, and may be an integer value. Alternatively, values may also be assigned to the get funds trigger and the get funds type, or to the send funds trigger and the send funds type. In addition, a data layer comprising information that describes parameters of a commercial transaction corresponding to the payment transaction may be transmitted, and may comprise, for example, shipping information or other information from an e-commerce communication protocol or protocols.

In another configuration, a method of executing a payment from a payor intended for a payee is disclosed, comprising creating a get funds trigger that carries information for selecting a method of making payment, creating a get funds type that carries information for selecting a method of receiving payment, creating an approval that carries information for determining the approval status of the payment, creating a send funds trigger that carries information for executing a transmittal of funds, creating a send funds type that carries information for selecting a method of receiving payment; and transmitting the get funds trigger, get funds type, approval, send funds trigger, and send funds type in a single message. A value may also be assigned to at least one of the get funds trigger, the get funds type, the send funds trigger, or the send funds type, or to the gets funds trigger and the get funds type. In addition, a data layer comprising information that describes parameters of a commercial transaction corresponding to the payment transaction may be transmitted.

In another configuration, a method of executing a payment to a payee from a payor is disclosed, comprising receiving in a single message a get funds trigger that carries information for selecting a method of making payment, a get funds type that carries information for selecting a method of receiving payment, a send funds trigger that carries information for executing a transmittal of funds, and a send funds type that carries information for selecting a method of receiving payment; and executing payment to the payee by a method corresponding to a value of the send funds type. A data layer comprising information that describes parameters of a commercial transaction corresponding to the payment transaction may be transmitted.

In another configuration, a data communication structure for transmitting payment information about a payment transaction, is disclosed comprising a get funds trigger entry that carries information for executing a retrieval of funds, a get funds type entry that carries information for selecting a method of making payment, an approval entry that carries information for determining the approval status of the payment, a send funds trigger entry that carries information for executing a transmittal of funds; and a send funds type entry that carries information for selecting a method of receiving payment. The structure may also comprise a data layer that carries information describing parameters of a commercial transaction corresponding to the payment transaction.

A payment execution system for carrying out a payment transaction from a payor to a payee is also disclosed, and comprises a payment execution computer, a plurality of remote payment nodes corresponding to a plurality of remote users, the remote payment nodes enabling the remote users to submit transaction data to the system; and a communications network. the payment execution computer is coupled to the plurality of remote payment nodes by the communications network, and transmits a payment message comprising a get funds type entry, a get funds trigger entry, an approval entry, a send funds trigger entry, and a send funds type entry.

In yet another configuration, a propagated signal for transmitting payment information about a payment transaction comprises a get funds trigger entry that transmits information for executing a retrieval of funds, a get funds type entry that transmits information for selecting a method of making payment, an approval entry that transmits information for determining the approval status of the payment, a send funds trigger entry that transmits information for executing a transmittal of funds, and a send funds type entry that transmits information for selecting a method of receiving payment. The signal may further comprise a data layer comprising information that describes parameters of a commercial transaction corresponding to the payment transaction, and may include information from an e-commerce communications protocol.

A computer processor implemented method of settling a plurality of payments between a first organization and a second organization is also disclosed, and comprises receiving a plurality of payment transaction notices corresponding to the first organization, receiving a plurality of payment transaction notices corresponding to the second organization, calculating a first net account status value for the first organization, calculating a second account status value for the second organization, executing a payment for the first organization, and executing a payment for the second organization. The payments may be executed on a scheduled basis or in response to a payment settlement request. The payment to the first organization independently of the payment to the second organization, and may be made through a clearinghouse. The organizations may be financial institutions or other types of organizations, such as corporations or other persons, and both may be organizations within a single larger organization, such as subsidiaries or governmental units. The payments may be executed by crediting or debiting an account, and reconciliation information may also be transmitted to the organizations.

In another configuration, a system for settling a plurality of outstanding payment transactions is disclosed, comprising a settlement computer, a plurality of remote payment nodes corresponding to a plurality of remote payment parties, the remote payment nodes enabling the remote users to receive payment information; and a communications network. The settlement computer is coupled to the plurality of remote payment nodes by the communications network, aggregates payment information comprising payment values corresponding to individual transactions involving the plurality of remote payment parties, and executes payments for the plurality of remote payment parties that are the net sum of the payment values. One or more of the remote payment parties may be a financial institution, and the payment values may correspond to transactions of customer of the financial institution, or the payments may be made to financial institutions for the remote parties. The number of payments executed by the system may be substantially fewer than the number of payment transactions.

Various embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram illustrating the relationships among entities in a system for the buying, selling, and payment for goods.

FIG. 2 is a block diagram illustrating a system for managing payments from payors to payees.

FIG. 3 is a flow chart illustrating a process for managing payments.

FIG. 4 illustrates a data structure for transmitting information that enables payment management.

FIG. 5 is a flow diagram illustrating one implementation of a process for enrolling a user of a payment management system.

FIG. 6 is a flow diagram illustrating one implementation of a process for executing a payment request.

FIG. 7 is a flow diagram illustrating one implementation of a process retrieving funds for a payment.

FIG. 8 is a flow diagram illustrating one implementation of a process for initiating a dispute process related to a payment.

FIG. 9a illustrates an enrollment form for entering user company demographics.

FIG. 9b illustrates an enrollment form for entering account set-up information.

FIG. 9c illustrates an enrollment form for entering role information for individuals within a payor or payee company.

FIG. 9d illustrates an enrollment form for entering information about an individual within a payor or payee company.

FIG. 10 illustrates a sample payment transaction form.

FIG. 11 illustrates an approval form.

FIG. 12 illustrates a sample reconciliation report.

FIG. 13 is a block diagram illustrating the relationship between and among participants in a funds settlement system.

FIG. 14 is a block diagram illustrating a computer suitable for implementing the various embodiments of the invention.

### DETAILED DESCRIPTION

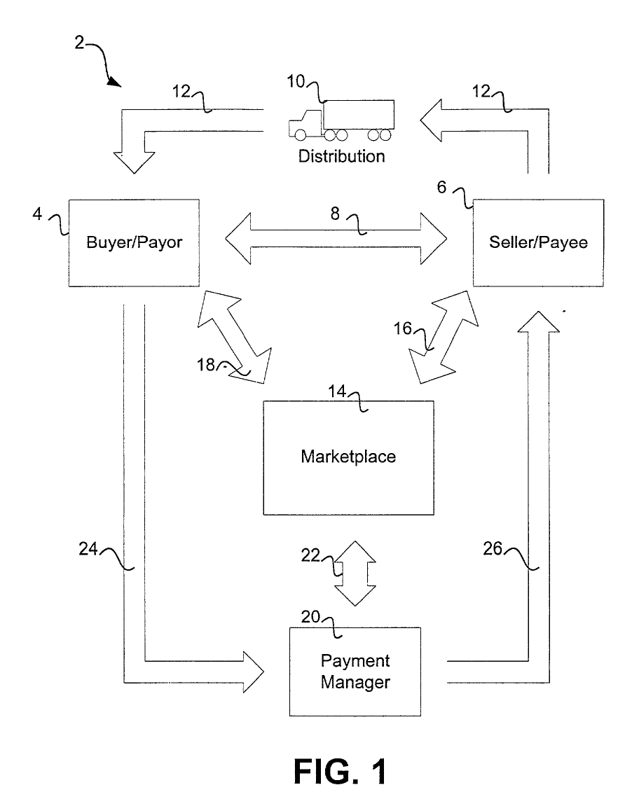

FIG. 1 shows a payment system 2 that enables and automates the execution of payments from a payor to a payee via an interactive network. Traditionally, payor 4, who may also be a buyer, would communicate with payee 6, who may also be a seller, through direct link 8. For example, payor 4 would buy products directly from payee 6, such as by shopping in a store or ordering out of a catalogue. More recently, marketplaces, such as marketplace 14, have provided indirect links between payor 4 and payee 6. Thus, payor 4 may communicate with marketplace 14 through link 18, and payee 6 may communicate with marketplace 14 through link 16. Marketplace 14 may be, for example, an internet eMarketplace. Marketplace 14 may provide trading partner matching, price negotiation, and formation of purchasing contracts between payor 4 and payee 6. In one common form, marketplace 14 may be an open platform that aggregates buyers and sellers of specific services or products in a particular field. Payor 4 may employ an automated procurement system, or eProcurement system, while payee 6 may employ an automated sales management system, or eCommmerce system. Common eProcurement systems include Ariba, Clarus, CommerceOne, Concur, Extensity, Intelisys, iplanet, Oracle, Remedy, and Rightworks. Although the payor and payee are discussed separately here, any user could be either a payor or a payee depending on the context of the transaction.

Traditionally, payments between payor 4 and payee 6 have been limited in this model. For example, payor 4 and payee 6 have been limited to the payment options offered by marketplace 14. Therefore, although marketplace 14 could provide for credit card payment, payor 4 and payee 6 would both have to use the credit card service. If payor 4 and payee 6 wish to use other payment options, they would separately decide on alternative payment options independent of marketplace 14. In this model the payment option selected by payor 4 would have to match the payment option selected by payee 6, such as line of credit payment, check, Swift wire, or other. In addition, the terms of payment and execution of payment would be controlled outside of Marketplace 14.

Payment manager 20 may enable payor 4 to make payments to payee 6 in a more flexible manner. Payment manager 20 may communicate with marketplace 14 through authorization link 22, such as a common communication channel. Alternatively, payment manager 20 may be a part of marketplace 14. Payment manager 20 may also be independent of marketplace 14, and may be selected by payor 4, or may be suggested by marketplace 14 for the benefit of payor 4 and payee 6 as a possible payment vehicle. Payor 4 or payee 6 could be any combination of an individual, a business, a government, or an entity of a government. For example, payor 4 could be a consumer or a business that seeks to purchase goods or services from payee 6 business. Alternatively, payor 4 could be a government making payments to a business for services rendered or making transfer payments to individuals. A single payor 4 could make payments to multiple payees 6, including by requesting multiple payments that share many characteristics. For example, payor 4 could request multiple payments by specifying a single payment method, but specifying multiple payment amounts and multiple payee 6 identities.

Payment manager 20 communicates with payor 4 through payment link 24, and with payee 6 through payment link 26. Payment manager 20 may be used to effect payment by a number of different payment methods, and may also receive and store information about multiple payment transactions. Although payment links 24, 26 are shown as direct links, the could also be indirect links, such as through financial institutions of which pay or 4 or payee 6 are members.

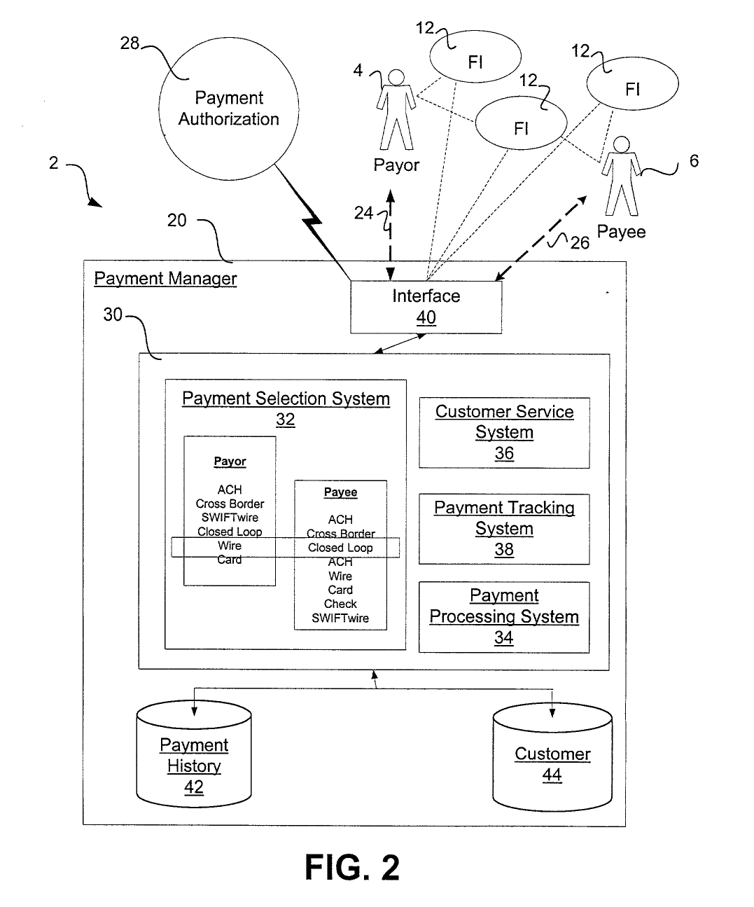

Payment links 24, 26 may be used to effect payment. For example, payment link 24 may be used to provide a payment authorization to payment manager 20, whereby payment manager 20 effects payment from payor 4 to payee 6. Payment may be made to payee 6 through payment link 26. Payments may also be made by payment manager 20 to financial institutions 12 (see FIG. 2) for payor 4 or payee 6. Payment authorization may also come from payor 4 indirectly through marketplace 14 by authorization link 22.

Payment system 2 can also effect shipment of goods that are purchased by payor 4. Shipment 10 may occur through any of a number of well known means. Although shipment 10 is shown in FIG. 1 as occurring directly from payee 6 to payor 4, shipment 10 could take place in many other ways, such as from a remote warehouse, through electronic means, or from a third party, or may be represented instead by the provision of a service or services for which compensation is paid. Information regarding shipment 10 may also be collected for integration with payment information that is collected by payment manager 20 or marketplace 14. In addition, the payment features of payment manager 20 may be employed even where there is not a sale of products or services.

FIG. 2 illustrates payment system 2 in more detail. Payment manager 20 may receive a payment authorization 28 that causes it to execute a payment from payor 4 through payment link 24 or to payee 6 through payment link 26. The payments may be effected directly, as shown, or indirectly, for example, through financial institutions 12 associated with payor 4 or payee 6, or through other means. The payment manager 20 may operate independently of financial institutions 12 or of the marketplaces. Payment authorization 28 may be provided directly from payor 4 or may be provided indirectly, for example, through an agent of payor 4, through an automated payment authorizer, through a marketplace, or by other means. Payment authorization could also be provided by payee 6 or independently of payor 4 or payee 6.

Interface 40 receives communications intended for payment manager 20 and sends communications from payment manager 20. Interface 40 may receive payment authorization 28 and cause one or more payment systems 30 to effect a payment or perform other process. Payment systems 30 may obtain information from databases 42, 44, from interface 40, or from other data sources.

Payment history database 42 may store information regarding previous payments made by or to payor 4 or by or to payee 6. The information may include the amount of a previous payment or payments, the party with whom the transaction occurred, the method of payment for payor 4 and for payee 6, the timing and terms of the payment, the goods or services ordered and received, cost accounting information, and documents and other data associated with the terms of the payment transaction. The information in payment history database 42 may be stored in the form of a data warehouse, and may be obtained from earlier transactions carried out by payment manager 20 or may be imported from outside of payment manager 20. The information can be used to perform a number of processes, including intelligent payment method selection, payment reporting, payment approval, order and payment reconciliation, transaction dispute management, billing management, cash position management, usage trending and analysis, participant benchmarking, and other historical analyses.

Customer database 44 may store information concerning payor 4 and payee 6, including profiles that identify payor 4 and payee 6 and their preferences, and business rules that express the preferred payment methods of payor 4 or payee in particular situations. Information in customer database 44 may be gathered directly from payor 4 or payee 6. For example, payor 4 may choose or establish a rule that selects a particular payment method in particular circumstances. As one example, payor 4 could establish a rule whereby payments below a predefined amount are paid by credit card, whereas payments above that amount are paid by ACH. Alternatively, payee 6 could establish a rule whereby payments from a particular type of payor (e.g., corporate or government) are received by a particular method. In addition, rules may be selected to affect the timing of payments, for example, by executing payment only upon notice that a shipment has left the seller or been received by the buyer. Payment manager 20 may present payor 4 or payee 6 with predefined rules from which the user may select, or a user may define unique rules.

Payment manager 20 may also generate new rules for payor 4 or payee 6, for example, using information in payment history database 42. As one example, payment manager 20 could compare types of payments received by payee 6 to other types of payments received by payee 6, and suggest that payee 6 change the method of payment of one of the types of payment. In particular, if payee 6 has a rule that requires wire transfers for payments from government sales, but payee 6 receives credit card payments for commercial sales, payment manager 20 may be programmed to recognize similarities between government payments and large commercial payments, and may suggest that payee 6 receive large corporate payments by wire transfer. Payment Manager 20 may also utilize expense information from payment history database 42 to suggest payment methods to payor 4 or payee 6 that are more cost effective than current rules would suggest. In addition, payment manager 20 may use payment history database 42 to identify payment trends between specific payors 4 and payees 6 to suggest more effective payment methods and terms. Payment manager 20 may also utilize payment history database 42 to develop or analyze risk profiles of payor 4 or payee 6.

Users may provide payment manager 20 with information regarding parameters of payment, or other user characteristics, so as to create a user profile. Users may be both payors and payees depending on the context of the transaction, so that any particular user could submit information regarding its preferences for making payments, its preferences for receiving payments, or both. Payment authorizers, such as electronic marketplaces and financial institutions, may also have their information stored in customer database 44. Information for any user could include identification information, such as a user name, user password, digital certificate, contact information for the user, tax identification numbers, or social security numbers. The information may also include financial information about the user, such as banking account numbers, and available methods of payment. In addition, the information may include preference information, such as preferred methods of payment. Although payment history database 42 and customer database 44 are shown as separate databases within payment manager 20, they could also be arranged in other ways, such as a single database, or as many separate databases, including databases outside payment manager 20.

Payment management systems 30 may execute numerous functions for payment manager 20. For example, payment selection system 32 may be configured to select a payment method for payor 4, payee 6, or both. Payment selection system 32 may select a payment method in a variety of ways. For example, payment selection system 32 may access information in customer database 44 that controls the type of payment from payor 4 or to payee 6, so that the selected payment method is a function of the parameters of the transaction and the payment rules. As an example, payor 4 may establish rules that control the type of payments for a transaction, depending on the size of the transaction, the type of goods or services exchanged, the mode of shipment, the location of the transaction, the timing of the transaction, the status of the payor's account, the length or type of relationship with the payee, or on other variables. The selected payment method may also be a function of payee's 6 profile, such as identification information, whether payee 6 is a merchant or an individual, the transaction rights possessed by payee 6, or the location of payee 6. For example, certain payment methods may not be capable of being made in particular locations or countries. Likewise, payee 6 may establish rules for controlling the method in which payee 6 receives payment that are similar to those established by payor 4. The selected payment method may also be a function of payor's 4 profile, such as credit rating, identification information, whether payor 4 is a merchant or an individual, and the transaction rights possessed by payor 4.

In addition, payment selection system 32 may calculate or may determine a payment method based on information other than rules, such as payment histories 42. For example, payment selection system 32 may analyze the trends of past payments by payor 4, or to payee 6, and determine a more effective payment method based on the trend data. For example, Payment selection system 32 may determine a trend in delivery performance by payee 6 and recommend a more risk averse payment transaction to payor 4. Payment selection system 32 may also utilize active payment information to determine the most efficient option that maximizes the use of money by payor 4 and payee 6. As an example, payment selection system 32 could review the current account position and outstanding open transactions of payor 4 and payee 6, and determine the future monetary needs of payor 4 and payee 6. From this information, payment selection system 32 could recommend the method or timing of the payment, including by delaying payment, providing payment to and from a third party, or otherwise structuring the payment. Thus, selection of a best option is not limited only to the least expensive option. Payment selection system 32 may also determine payment method and timing for payor 4 and payee 6 based on the least expensive method for each. For example, based on payment transaction information, payment selection system 32 could determine that standard rules would have configured a credit card transaction between payor 4 and payee 6, but that an ACH transaction is more cost effective for payor 4, and that a SWIFT wire transaction is better for payee 6.

Advantageously, payment selection system 32 may select a payment method for payor 4 that is independent of a payment method selected for payee 6, in that the two payment methods may differ. As shown, payor 4 may have a plurality of available payment options, and payee 6 may have a plurality of available payment options, including options that differ from those available to payor 4. Using information from customer database 44 or from another source, payment selection system 32 may select a payment method for payor 4 such as by using business rules for payor 4. Independently, payment selection system 32 may select a payment method for payee 6, such as by using rules for payee 6. In FIG. 2, this independent selection process is represented by two side-by-side sliding arrays of available payment methods that are aligned under a payment selection window according to payment rules. As a result, payment manager 20 is capable of standardizing and matching order information across all available payment methods or vehicles.

For example, for a particular transaction, payor 4 may put in place rules that require payment by credit card. For the same transaction, payee 6 may establish rules that require it to receive payment by wire transfer. Payment selection system 32 is capable of accommodating both payor 4 and payee 6 in such a situation. As a result, payment manager 20 is capable of serving payors and payees who do not agree on the particular payment method for a transaction. This ability allows payment manager 20 to serve customers without requiring prior negotiation between payor 4 and payee 6 regarding the payment terms of a transaction. In addition, payment may be accomplished more easily across borders, since payor 4 may pay in its local currency and payee 6 may be paid in its local currency, without having to negotiate such a payment plan with each other.

Payment rules may also be influenced by terms of contracts between payor 4 and payee 6. Payment selection system 32 may access information regarding contractual requirements between two parties and may select methods and timing of payments that meet the contractual terms.

Payment processing system 34 may be employed to execute a payment from payor 4 to payee 6. Payment processing system 34 may receive information on the payment method from payment selection system 32, and may execute the appropriate commands to carry out such payment by the selected methods. For example, payment processing system 34 may execute an order to a credit card processor of payor 4, so as to debit the account of payor 4. For the same transaction, payment processing system 34 may execute a command to a financial institution 12 for payee 6 that results in a wire transfer from the financial institution 12 to payee 6. Such payments may be executed by any of a number of well-known methods, and through any of a number of common financial institutions or processes.

Payment processing system 34 may also control the timing of payments, and may execute payment from payor 4 independently of payment to payee 6. For example, through predetermined rules, payor 4 may state a preference to execute payment only upon receipt of ordered goods, or receipt plus a predetermined time. Likewise, payee 6 may state a preference to receive payment upon shipping the goods. Payment processing system 34 may accommodate this de-coupling of payment timing. Where there is an overlap in timing of the payments, payment processing system 34 may obtain temporary credit for payor 4 or payee 6, and where there is a gap in the timing of payments, payment processing system 34 may transfer the balance to a third party or may alter the timing of the payments according to customer preferences or other rules. Payor 4 and payee 6 may also establish preferences regarding the amount of compensation they will require in exchange for taking on a certain amount of transaction risk, and payment processing system 34 may select which party will carry the risk based on the least-cost preference between the parties.

Payment processing system 34 may be configured to provide information and control over the payment process for payor 4 and payee 6. For example, payment processing system 34 may provide for a payment authorization process for payor 4. In doing so, Payment processing system 34 may verify the payment authority of a particular individual at payor 4 and compare that authority to predetermined payment rules. If the individual's authority is insufficient under the rules, payment processing system 34 may block payment until authorization has been obtained by an individual at payor 4 with appropriate authority.

Payment processing system 34 may execute a process for obtaining payment authorization. In doing so, payment processing system 34 may identify an individual with payment authority and route an authorization request to that individual, for example, by electronic mail or other means. As an example, different individuals at payor 4 may have authority to make a purchase than those who have authority to make payment for the purchase. As a result, a payment authorization 28 may be received from a marketplace as the result of an order of products, but payment cannot be authorized because the individual who placed the order does not have adequate payment authority. Payment processing system 34 may be configured to communicate back to payor 4 that payment authority is lacking and may seek out an individual with payment authority. When an individual with adequate payment authority has authorized payment, payment processing system 34 may release any hold on payment. In addition, payment manager 20 may communicate to the marketplace or to payee 6, or individuals therein, that full payment authorization has been received.

Payment tracking system 38 may be configured to offer information regarding the status of the payment process. Payee 6 may request information from payment manager 20 regarding whether payment has been made, and may compare that information to other information about the transaction, for example, information about shipping. In this manner, payee 6 may determine whether shipment has occurred and whether payment for the same transaction has occurred. In like manner, payor 4 may also track payments and compare them to other transaction information. Payment manager 20 may also receive information about shipping and aggregate that information with information about payment, and provide a report to payor 4 or payee 6.

Payment tracking system 38 may also aggregate information from multiple payments. For example, payment tracking system 38 may provide to payor 4 or payee 6 information about any previous transactions that payor 4 or payee 6 have made using payment manager 20 or other payment systems. Payment tracking system 38 may obtain information about other transactions from payment history database 42 or from another available source, such as a payment database from a third-party system. Advantageously, payment tracking system 38 may be configured to report information on transactions that occurred through multiple marketplaces, so that even if payor 4 transacted business at different locations, for example through multiple internet sites, payor 4 could still receive information about all of those transactions in one location through payment manager 20. Other reports that may be produced with access to data from multiple transactions include spending analyses, audit summaries, usage summaries, partner analyses, dispute reporting, exception reporting, billing activity, and additional reports.

Payment manager 20 may also accomplish reconciliation of payment information with order information for a transaction. Payment manager 20 may produce to, or receive from, an order tracking system a match key, and may use the match key to pair order data received from the order tracking system with corresponding payment information. Using this information, payment manager 20 may present to the user a combination of order information and payment information. As an example, a single report can display the status of the payment and the status of shipment side-by-side. Because payment may be triggered by an event such as delivery in the system described, reconciliation may occur automatically as part of the event processing. Where information provided by shipping or receiving systems is insufficient to allow auto-reconciliation, payment manager 20 may receive additional information from other sources to facilitate reconciliation or provide information to other systems to perform the reconciliation process. For example, payment manager could obtain information directly from payor 4 or payee 6, such as by providing the user with a blank ship/receive notice for the user to fill out and submit.

In addition, payment manager 20 may obtain order information from multiple order tracking systems and group it with payment information in a single location. The payment information may be obtained from a data warehouse such as payment history database 42. In addition, users may be allowed access to data involving their transactions so that they may conduct queries to track the performance of their payment decisions. Access to the data may be restricted only to the user whose transactions are reflected by the data and only to certain individuals under the user's account.

Payment manager 20 may use customer service system 36 to facilitate the resolution of payment errors. Error conditions detected during normal processing, for example, incomplete data forms, data that may be fraudulent or entered in error by users, and payment events that are not consistent with the configured payment transaction, are processed by components of customer service system 36. In addition, disputes initiated by a payor or a payee are processed by customer service system 36. Business rules for payment manager 20 and users of the system define the workflow that customer service system 36 executes to facilitate the resolution of disputes. Also, non-standard conditions that are not errors in the payment transaction may be routed to customer service system 36 and processed for resolution. Non-standard conditions may include explicit payment instructions from a payor that do not conform to the business rules defined in payment manager 20.

As described, payment manager 20 may be configured to provide end-to-end management of the payment process, including negotiation, order, payment, settlement, reconciliation, and audit. These actions allow the market to be more transparent to payors and payees, allow payors and payees to enforce corporate payment policies consistently across many marketplaces, lower administrative costs, allow transaction information to be aggregated, provide for best value payment selection, and permit review of payment performance.

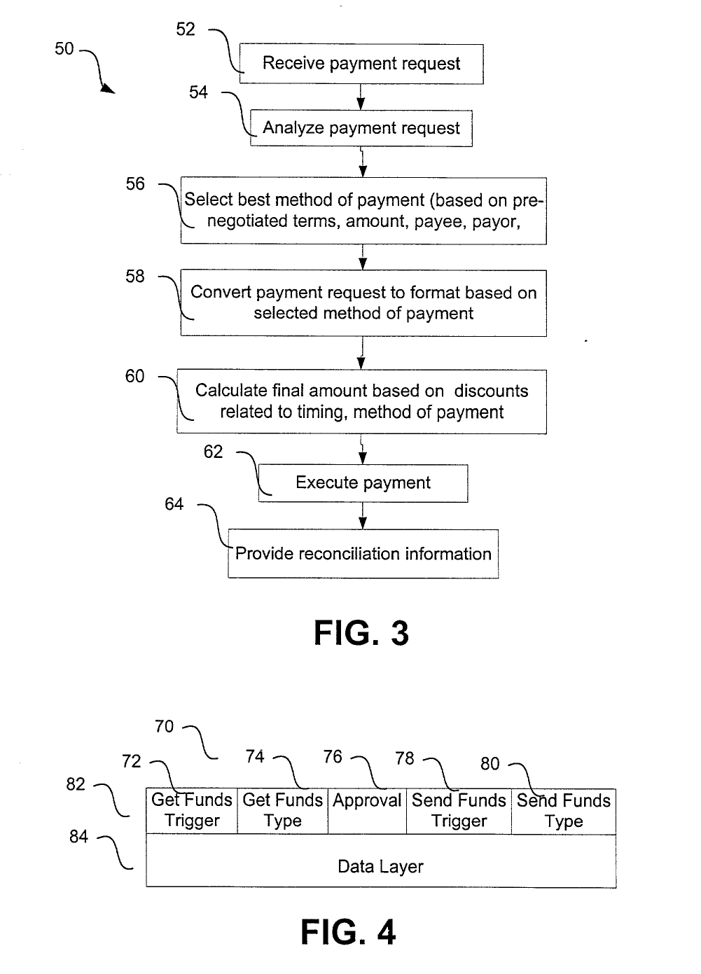

FIG. 3 is a flow chart 50 illustrating one implementation of a process for managing payments. As a first step, the process receives a payment request 52. The payment manager then analyzes the payment request 54, and selects a best method of payment 56 for that request. The selection may be based on a number of factors, such as pre-negotiated terms between a payor and a payee, the amount of the transaction, the type of goods purchased, rules established by the payee, or rules established by the payor. The payment method may be different for the payor than it is for the payee. The payment system then converts the payment request to a format based on the selected method of payment 58 for both the payor and the payee, and calculates a final amount based on discounts related to timing and the method of payment 60 for the payor and the payee. When appropriate information about the payment has been determined, the system executes payment 62 and may then provide reconciliation information 64 to the payor, the payee, or both.

Payment manager 20 may be used to complete payment between a purchaser and a merchant in an e-commerce application. In an example of such an application, a purchaser visits an Internet site on which goods are listed for sale. The purchaser then selects items to purchase and is prompted by the site to select a payment service from among a list of services that includes payment manager 20. The option to select payment manager 20 may be presented to the user as though payment manager 20 is a part of the Internet site or as an independent site. If the purchaser wishes to use payment manager 20, the site directs the purchaser to payment manager 20. If the purchaser is not yet enrolled with payment manager 20, the user may be taken through an enrollment process. Once the purchaser is enrolled, he or she may be presented with a list of the payment methods available, with the optimum payment option selected.

Payment manager 20 may also be used for large-scale transactions between and among businesses. For example, a business may enroll with payment manager 20, either directly or indirectly through a third-party, and provide information regarding individuals within the business having purchasing authority and payment authority. The business may also establish rules regarding payment, such as what payment methods to use in particular situations and the approvals required for particular payments. An individual at the business may then make a purchase from an Internet site. The individual may select to have payment manager 20 handle the payment, or that choice may be made automatically based on preestablished business rules. Payment manager 20 may then determine a preferred payment method for the purchase based on parameters of the purchase, such as the type of goods purchased, the party from whom the goods are purchased, or the amount of the purchase. Payment manager 20 may then determine whether approval for the payment is needed. If approval is not needed, payment manager may execute payment according to payment rules, whether pre-defined or computed at the time of the transaction. If approval is needed, payment manager 20 may seek approval, either from the individual who made the purchase or from another individual, such as a financial manager at the business. The approver may review the payment method and payment terms computed by payment manager 20, and may approve the payment, or alter some of the terms and then approve the payment. If approval is not to be made by the individual who made the purchase, payment manager 20 may provide for the individual who made the purchase to provide comments for the approver, and may also route the payment request to one or more approvers according to parameters of the purchase and pre-determined rules. For example, all purchases above a particular amount may be routed to more than one manager or to a senior manager.

In addition, a payor could establish numerous payment rules to minimize the need for approval. For example, a payor could have payment manager 20 make all payments below a certain amount automatically. The amount could vary depending on the payee or on the type of transaction. A payor could also choose to aggregate multiple payments into a single payment, for example, where the payor expects to make many payments to a single payee. A payor could also increase the automatic payment amount for a particular payee over a period of time as the payee becomes more trusted as trading partner. In addition, payment manager 20 could access or compile information that indicates a payee's reliability and could provide that information to the payor for inclusion in, or as an input to, payor's rules. In addition, payment manager 20 may provide a number of standard rule sets, such as a set of rules for escalating automatic payment amounts by certain amounts over the course of a trading relationship, and make the rule sets available to all payors or a subset of payors.

Payees may also interact with payment manager 20 in a like manner. In particular, payees may establish rules for selecting preferred payment methods and for setting the timing of the payments. In particular, a payee can enroll with payment manager 20, although if the payee only needs to act as a payee, it could avoid presenting information regarding its ability to make payments. A payee may also choose to receive payments of a certain amount by a certain method, or may have multiple payments aggregated into a single payment.

A payor could also initiate enrollment for a payee. For example, a purchaser could enroll with payment manager 20 and make an offer to buy a product, where the seller's enrollment is a condition to the purchase. It the seller chooses to carry out the transaction, the seller may enroll with payment manager 20, perhaps providing only information regarding a preferred payment method and minimal identifying information, and receive the payment.

FIG. 4 illustrates a data structure 70 for defining a payment request configured by payment manager 20. Data structure 70 may contain all required information for communicating between and among users of payment system 2 to control payment processing. Data structure 70 may also include data that is not required to control payment processing, but that provides additional information for better processing or tracking payments.

Data structure 70 may comprise core payment information 82, including a get funds trigger 72, get funds type 74, approval 76, send funds trigger 78, send funds type 80 and Data layer 84. Each piece of core payment information 82 may comprise an integer that represents a member of a list that corresponds to the values that may be held by the item. Alternatively, the value of any particular item may refer payment manager 20 to a source other than the list that corresponds to the piece of core payment information 82.

Get funds trigger 72 may define the event or events that must occur in order to enable the retrieval of funds from a payor. Get funds trigger events may include, for examples, the ordering of goods, shipment of goods, receipt of goods, or the expiration of a set amount of time from a particular date. Get funds type 74 may define the payment method for retrieving funds from a payor. Get funds types may be any generally accepted methods of financial settlement, variations of these methods, or unique methods required by specific payors or payees. Approval instructions 76 may be any workflow component defined by the payor that affects execution of the retrieval of funds by payment system 2. Rules may be set up that govern when approval is required and how the approval is acquired. Send funds trigger 78 may define the event or events that must occur to enable the transferring of funds to a payee. Send funds trigger events may include, for example, the ordering of goods, shipment of goods, receipt of goods, or the expiration of a set amount of time from a particular date. Send funds type 80 may define the payment method for transferring funds to a payee. Send funds types may be any generally accepted methods of financial settlement, variations of these methods, or unique methods required by specific payors or payees.

Data layer 84 may be be provided along with core payment information 82 to provide core functionality, additional functionality, or both. Data layer 84 may be communicated as part of data structure 70, and may be made available to recipients of data structure 70. Data layer 84 may comprise information needed to execute core payment information 82, as well as additional data elements that define the payment instructions, payor and payee terms and conditions, detail of goods ordered and received, shipping instructions, and mapping of accounting data to payor or payee financial systems. For example, data layer 84 may include information related to a purchase order for a transaction under various on-line commerce standards, such as ANSI, xCBL, or cXML, or RosettaNet. Data layer 84 may also include information relating to an invoice for a transaction. In one embodiment, data layer 84 may comprise a superset of all information communicated by a plurality of on-line commerce standards.

In practice, data structure 70 may be transmitted by means of XML tags. Various portions of data structure 70 may be populated by different participants to a transaction. For example, a marketplace may initially populate data layer 84 with information regarding a transaction, such as the identities of the parties to the transaction, the good or service exchanged, the amount paid, and other terms of the transaction. The marketplace may then pass data layer 84 to payment manager 20 for payment processing. Payment manager 20 may then add core payment information 82 to data layer 84 to produce data structure 70. For example, payment manager 20 may determine, by using business rules or another method, payment methods, payment scheduling, and approval requirements for the transaction and may provide the information in core payment information 82.

Data structure 70 may be used by each of the participants to a transaction. For example, a marketplace may accumulate data on transactions that were completed at the marketplace and may use that information to study the effectiveness of the marketplace. Payment manager 20 may also use data structure 70 in many ways. For example, payment manager 20 may accumulate data on transactions, including payment data, to discern trends in the payment operations of a use of payment manager 20, and may use the information to suggest more efficient payment methods for future transactions. As one example, payment manager 20 could look to payments made to a particular payee and suggest that a payor provide automated payment to the payee for certain transactions, so that payor may save money processing payments to the payee.

Payment manager 20 may also use data structure 70 as a means to accomplish interparty settlement of payment accounts. For example, payment manager 20 may accumulate transactions into a total transaction amount over a set period of time, and may place a hold on payments related to a particular payor. At the end of the period of time, payment manager 20 may cancel the held payments, and may instead execute a single payment for the net of the held payments. Payment manager may take such actions with respect to particular payors or payees, or may also take such actions with respect to particular financial institutions. For example, using the information in data structure 70, payment manager 20 may provide authentications and guarantees for payments to financial institutions, but may refrain from executing actual payments, such as ACH orders.

Payors and payees may also take advantage of data structure 70. For example, payment manager 20 may “push” information regarding pending or completed transactions on a scheduled basis. Such information may include reconciliation information and other information about the performance of transactions. Payors and payees may then analyze the information using their own analysis tools, and may generate custom reports to track their transaction and payment histories and trends.

Data structure 70 may also be provided in a manner that ensures security for participants. For example, information transmitted to a marketplace may omit information, such as payment information and information for tracking and reconciliation. Alternatively, information transmitted to a payor or payee may omit certain information regarding the other party to the transaction.

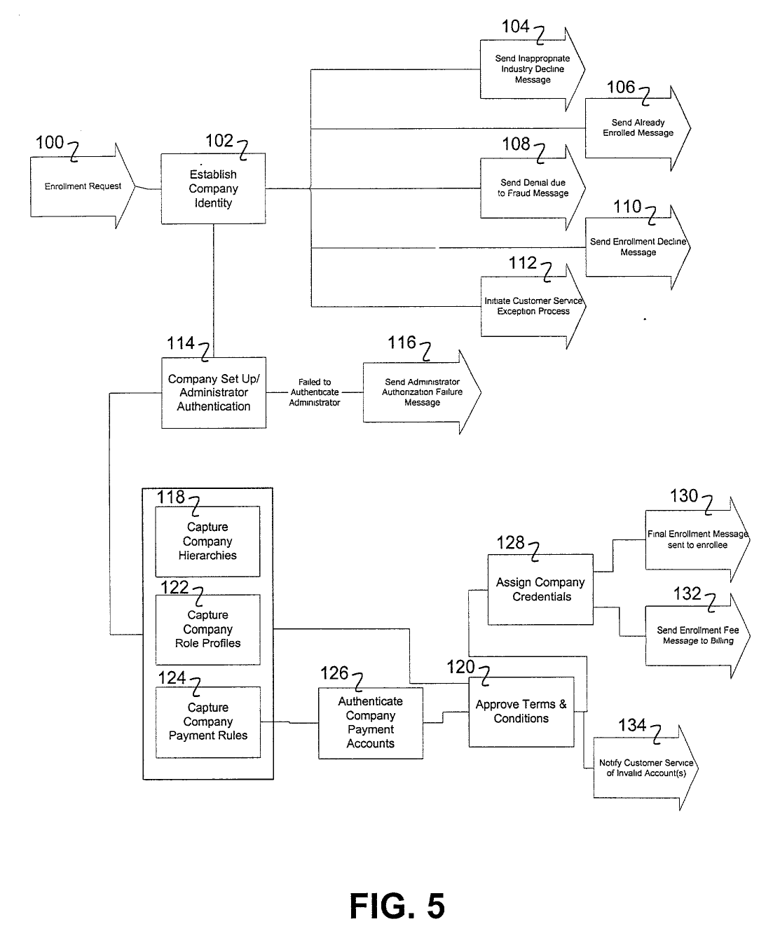

FIG. 5 is a flow diagram illustrating one implementation of a process for enrolling a user of a payment management system. A user may initiate the enrollment process by submitting an enrollment request 100. The enrollment may be initiated before the user needs payment services, or the enrollment may be made in conjunction with a “spot purchase.” The user may be directed to the enrollment process by a marketplace 14. Once a user enrolls with payment manager 20, it will not generally be necessary to re-enroll, even if the user is directed to the payment manager by a different marketplace 14.

Enrollment request 100 may be made electronically, for example, over the Internet, and may be made directly to payment manager 20 or indirectly through an intermediary, such as a marketplace 14. Marketplace 14 may direct the enrollee to a separate site for enrollment, or the enrollment process may be seamless with marketplace 14.

In response to an enrollment request, payment manager 20 first seeks to establish the identity of the enrollee 102, whether the enrollee is an individual acting on his or her own behalf or is a business or organization. For example, payment manager 20 may request the name, address, Dun & Bradstreet number, SIC code of the enrollee company, or the enrollee's tax identification number.

The enrollee identity information may be used to determine whether the enrollee's request is proper or improper. For example, if an enrollee has submitted an inappropriate SIC code, payment manager 20 may return a message 104 declining enrollment. Payment manager may compare the identity information to information in existing system databases to determine whether the enrollee is already enrolled. If so, payment manager 20 may return a message 106 notifying the enrollee that enrollment is not necessary. Payment manager 20 may also compare the identity information to known identity information to determine whether the attempted enrollment is fraudulent. For example, payment manager 20 may be programmed to identify the location of the enrollee and compare that location (whether actual or virtual) with known locations of potential users. If the location of the enrollee does not match a location for the user with which the enrollee has identified itself, the system may detect an attempted fraud and return a denial message 108. In addition, if the enrollee has previously enrolled but the account was deactivated for cause, payment manager 20 may return a message 110 declining enrollment. For example, if a company has previously utilized payment system 20 but was determined to be a financial risk, attempts to re-enroll would require additional review before service would be reactivated.

Certain errors in establishing an enrollee's identity may be correctable through an exception process 112. For example, payment manager 20 may perform a credit screening on an enrollee and the enrollee may fail that screening. In response, payment manager 20 may seek additional information from the enrollee in an attempt to obtain additional credit information. Alternatively, payment manager 20 may direct the enrollee to an alternative credit source, and then continue the enrollment process once the alternative means of credit has been obtained.

If an error is generated because payment manager 20 cannot match an enrollee to a list of potential users, payment manager 20 may initiate an exception process to obtain additional information from the enrollee by which the enrollee's identity may be adequately verified. In a like manner, if an enrollee has been previously enrolled, payment manager 20 may recognize that previous enrollment and begin a process to reconcile the new attempt to enroll with the previous enrollment.

Once the enrollee's identity has been established, payment manager 20 may conduct administrator authentication and account set up 114 for the enrollee. As part of initial enrollment, the enrollee has identified a specific individual or individuals to administrate the enrollment process. Payment manager 20 may require authentication and issuance of credentials before it will accept enrollee information from the individual or individuals. If payment manager 20 is not able to authenticate the administrator, message 116 will be issued. Among the parameters that may be provided by the administrator are enrollee hierarchies 118, role profiles 122, and payment rules 124. Enrollee hierarchies may define user organizations, rules inheritance schemes, approval routings, and user access roles and rights. Role profiles 122 may define profiles that apply to a plurality of users, so that full profile information need not be provided for each individual and so that profiles may be changed for an entire group of individuals easily. For example, all managers having a certain approval power may be grouped in a common role profile.

As an additional step in the account set-up process, payment manager 20 may capture company payment rules from the enrollee in a number of ways. For example, payment manager 20 may present the enrollee with a number of payment scenarios and allow the enrollee to select preferred payment actions for each scenario. Alternatively, payment manager 20 may present the enrollee with multiple options under a number of different payment parameters. These parameters may include events on which payment funds should be retrieved, whether payment approval is required and how it should be accomplished, events on which funds should be sent, and allowable payment methods. For example, funds may be retrieved or sent on order, on shipment, on receipt, or after a certain amount of elapsed time. Also, payment methods may include, for example, credit card, closed loop, ACH, Cross Border ACH, Wire, Swift Wire, or check. Payment manager 20 may also obtain information from the user regarding each payment method, such as account numbers and access codes.

After receiving information on an enrollee's payment accounts, payment manager 20 may authenticate that information 126, and may determine whether the user meets the terms and conditions 120 for use of payment manager 20. For example, payment manager 20 may send inquiries to financial institutions responsible for the payment accounts or to third parties that are able to authenticate the information. If any information cannot be authenticated, payment manager 20 may notify the enrollee and may give the enrollee the opportunity to correct the information or remove the particular payment account from the enrollee's list of preferred payment accounts. Once the account information is authenticated, payment manager 20 may assign the enrollee credentials 128 to allow the enrollee to use payment manager 20 in the future. For example, the enrollee may be given a user identification and a password. Alternatively, other verification methods, such as digital signatures, may be used. Payment manager 20 may alert the enrollee that user credentials have been assigned 130 and may send a message to create an account for the user, and may send a enrollment fee message to a billing system 132.

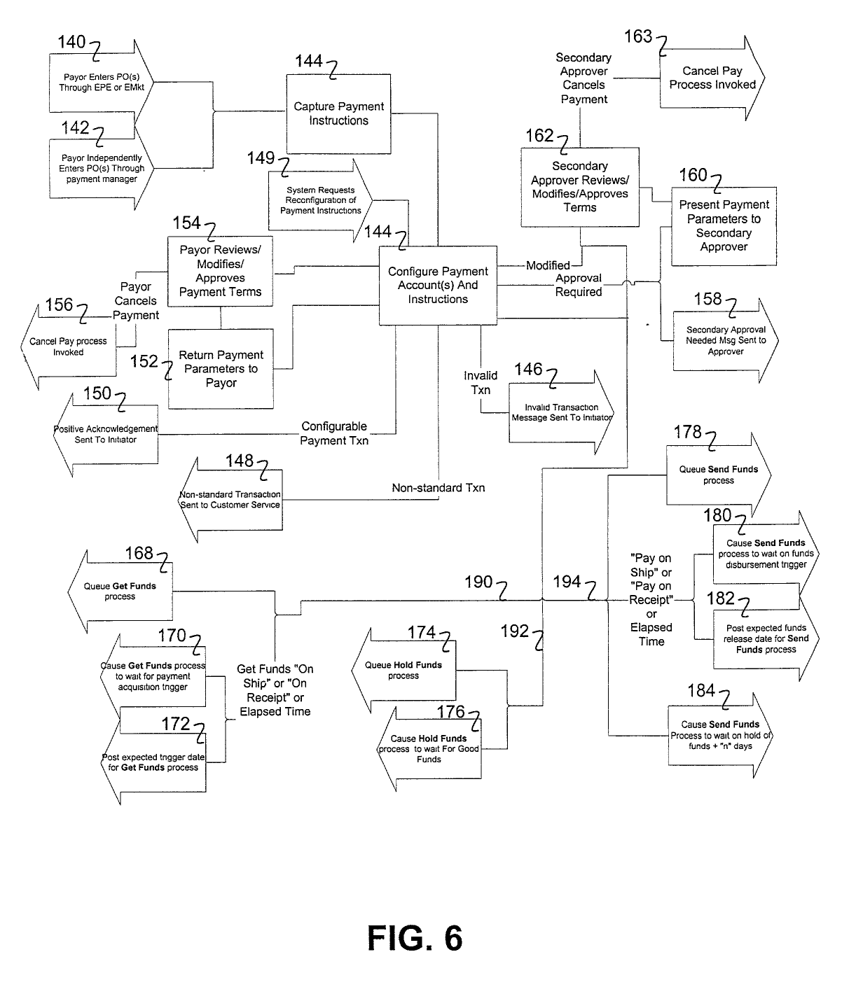

FIG. 6 is a flow diagram illustrating one implementation of a process for executing a payment request. Referring to FIG. 2 and FIG. 6, the payment process may be payor-initiated, in that the payor may provide purchase order information directly 142 to payment manager 20, or the payor may provide purchase order information to a third party, such as a marketplace or electronic procurement engine (EPE) that causes the third party to initiate a payment request 140 to payment manager 20.

Upon receiving a payment request, payment manager 20, through payment selection system 32, may configure payment accounts and instructions 144 by applying rules stored in customer database 44 to information received with the payment request, or may configure a payment transaction based on the instructions contained in the payment request. Initially, payment selection system 32 may attempt to configure the transaction and determine if it is invalid, non-standard, or a proper configuration. If the transaction is invalid, for example, if customer rules do not allow for a proper payment configuration, no available account can be identified, required information is not supplied, or another irregularity is identified in the payment request, payment selection system 32 may send a message 146 to the initiator indicating that the transaction is invalid. If the transaction is non-standard, for example, if payment configuration instructions are received within the payment request but do not conform to customer rules, payment selection system 32 may send a message 148 to customer service system 36, to cause additional processing to resolve payment configuration. In either event, payment selection system 32 may request reconfiguration of the payment instructs 149.

Upon successful configuration, payment selection system 32 may return a message 150 to the initiator indicating that the transaction is properly configured. Based on the results of configuration and customer rules, payment selection system 32 may return payment configuration results to payor for review and acceptance 152. Payor may accept, select an alternative configuration 154, or cancel 156 the payment configuration.

Payment selection system 32 may also provide for approval workflow 160 in certain circumstances before payment may be executed. Rules may be set, for example, that require payments above a specified dollar limit to be reviewed, but allow payment manager 20 to complete all other payments below that value without approval. The payor may also set other standards for identifying payments that require approval. Payment manager 20 may notify approver(s) when payment configurations are pending by sending an electronic message 158 or by other means of communication. Payment manager 20 may provide the approver with an opportunity to accept, select an alternative configuration, or cancel the payment configuration 162. If the approver declines to approve payment, and instead cancels the transaction, payment manager 20 may invoke a cancel pay process, and may notify the payor, the payee, and the marketplace that the transaction should be voided.

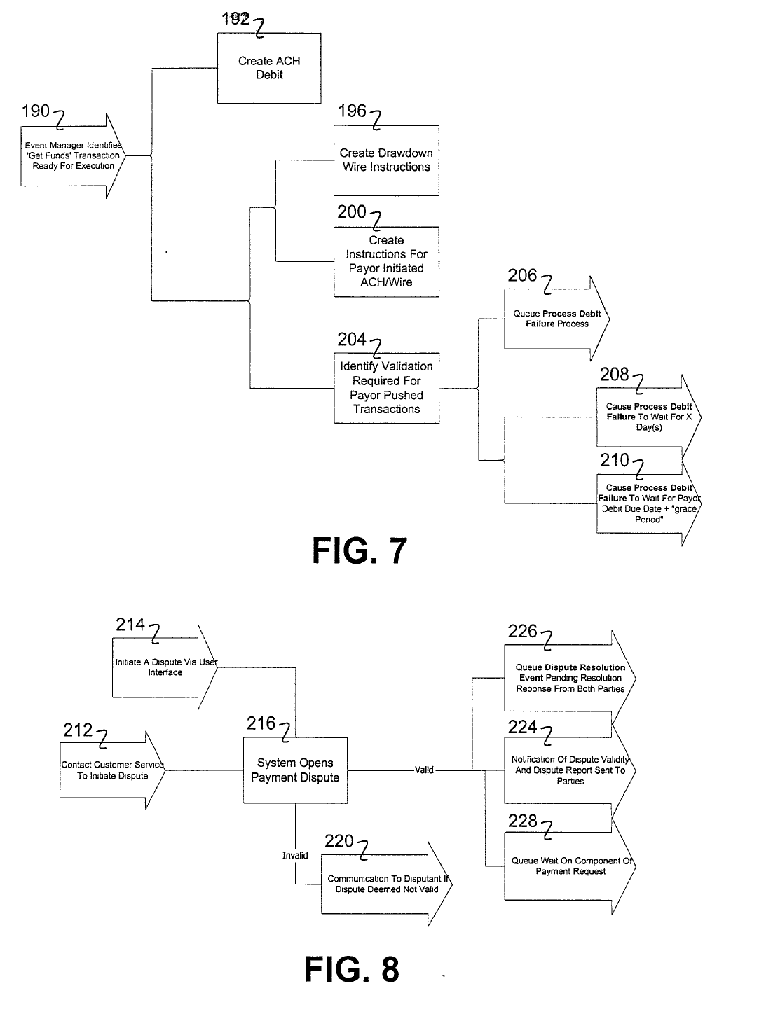

Many options are available to the payor and payee as payment methods. For each payment transaction, payment selection system 32 may enable three main processes for payment execution. These processes, as shown in FIG. 7, are described as the get funds 190, hold funds 192, and send funds 194. To carry out fund retrieval, payment selection system 32 may queue a get funds process 168 that waits for a payment acquisition trigger 170. The acquisition trigger can occur, for example, from the shipment of goods by the payee, from the receipt of goods by the payor, or by the expiration of a set amount of time from a particular date. Additionally, an expected trigger date 172 may be provided to permit additional flexibility to the system that provides, for example, a means of calculating the amount of funds that must be available at any time to meet all expected funding commitments.

Hold funds 192 may be enabled to validate that funds received through get funds 190 are sufficient and available to send funds 194. Upon acceptance of the payment transaction by the payor, the payment selection system 32 may queue hold funds 174 and cause hold funds 174 to wait for good funds 176. Good funds 176 may exist as money deposited into a payment system 2 account from the payor's account defined by the payment transaction, as a valid credit card charge against the payor's defined card account, or as other deposits as defined by the payment method. In addition, based on the payment method used to retrieve funds from the payor, other requirements, such as time on deposit, may be necessary to determine that funds are good.

As noted, sending of funds may be independent of retrieval of funds. Payment selection system 32 may queue the send funds process 178 and cause it to wait until a fund disbursement trigger is sent 180. The disbursement trigger can occur, for example, from the shipment of goods by the payee, from the receipt of goods by the payor, or by the expiration of a set amount of time from a particular date. Additionally, an expected trigger date 182 may be provided to permit additional flexibility to the system that provides, for example, a means of calculating the amount of funds that may be received at any time. Payment selection system 32 may place a delay on the sending of funds in response to an instruction to hold funds 184.

FIG. 7 is a flow diagram illustrating one implementation of a process for retrieving funds from a payor. Within payment processing system 34, an event manager may be configured to track payment events and generate operation instructions upon the occurrence of those events. For example, the event manager may receive notice that goods related to a transaction have been received. In response, the event manager may generate an instruction to retrieve funds 190. The method by which the funds are retrieved will depend on the method selected by the payor or, alternatively, the method selected for the payor by the system. As an example, payment processing system 34 may create an ACH debit 192 and add the debit to a queued ACH file. Alternatively, a wire transaction may be created 196 and added to a queued wire file. Payment processing system 34 may also create instructions for a payor-initiated ACH transfer 200 and add the instructions to a queue of ACH “push” instructions. A queued push instruction may be monitored for completion 204 by payment processing system 34 and subsequent events queued to handle failure of the push instruction 206. Payment manager 20 may also hold certain transactions in queues until the end of a period of time, and execute transactions as functional aggregations of many other transactions. In this manner, payment system 20 may provide for a lower volume of transactions, and thus a lower cost for payors and payee.

FIG. 8 is a flow diagram illustrating one implementation of a process for initiating a dispute process related to a payment. A dispute process may be initiated directly by a user 214 or by a user contacting a customer service representative 212. When a dispute is initiated, payment manager 20 opens a dispute 216 and gathers data regarding the payment transaction from payment history database 42. Payment system 2 may compare the payment transaction data to predetermined standards for disputable and indisputable transactions to determine whether the dispute is valid or invalid. For example, a payment transaction that is older than a defined period of time may no longer be disputable by the payor. If the dispute is invalid, payment manager 20 may transmit to the disputant an indicator that the dispute is invalid 220. If the dispute is valid, the payment system may generate a dispute report using the data regarding the payment transaction 224 and send a dispute report to the relevant payor and payee. In addition, a valid dispute may queue certain hold events 228, that inhibit the further movement of funds from a payor or to a payee.

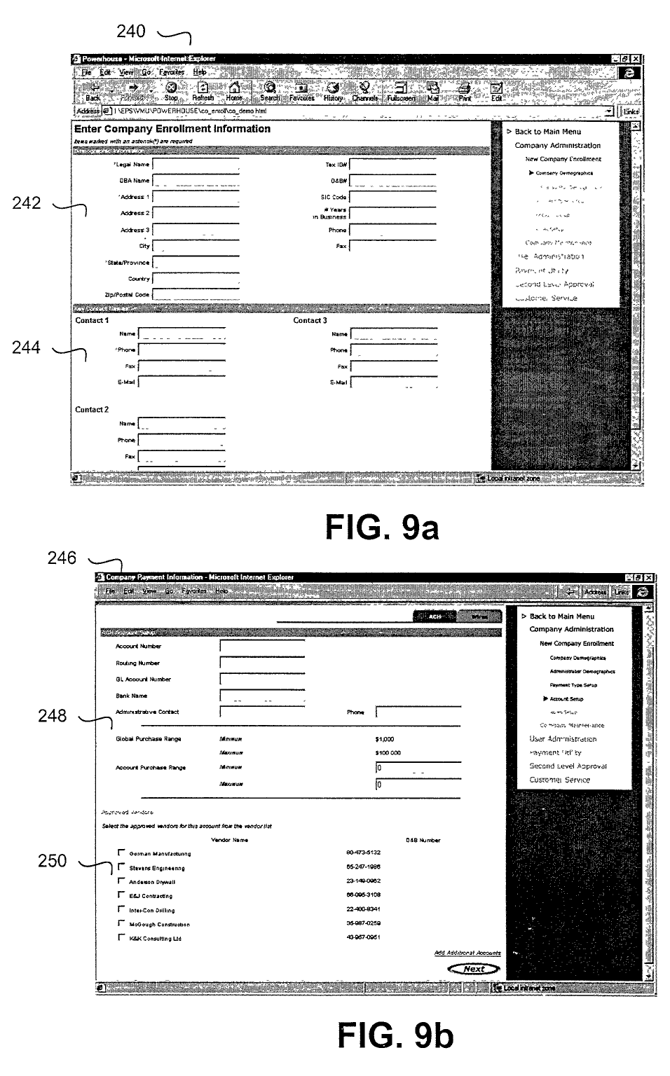

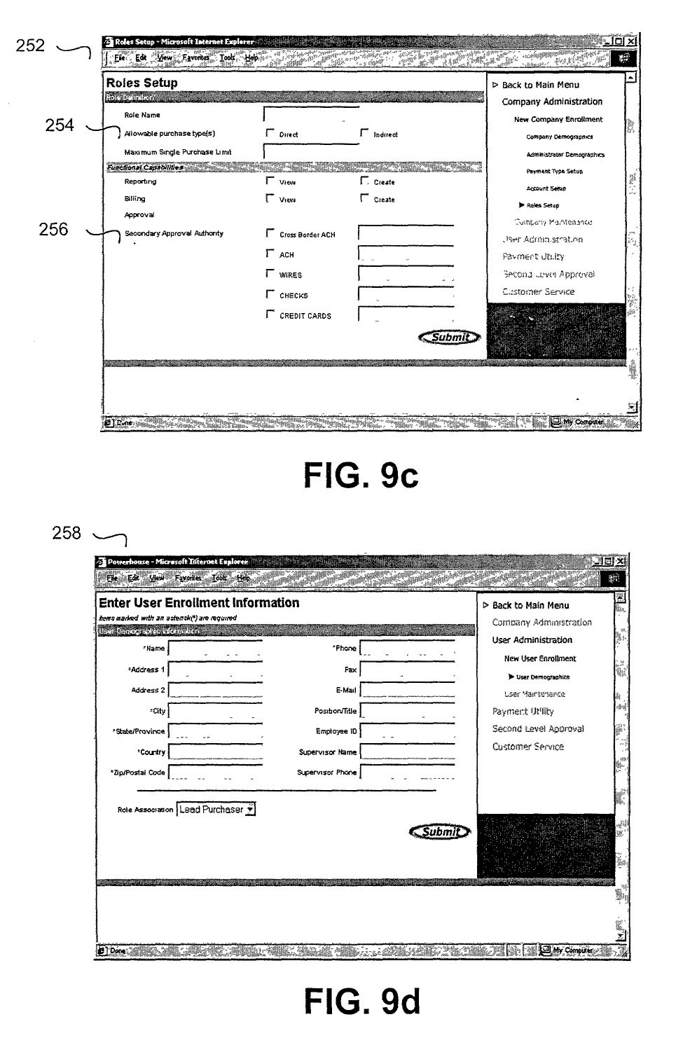

FIG. 9a illustrates an enrollment form 240 for entering user company demographics. Form 240 may be provided to a payor or payee along with other forms to receive information about the payor or payee. As shown, form 240 is configured to receive information from a user that is an organization, such as a corporation. Demographic information area 242 may receive information regarding the user, such as a user name and address, SIC Code, D&B number, and tax ID number. Contact area 244 may receive information regarding individuals who work for the organization or are affiliated with the organization, who will be interacting with payment manager 20. In particular, contact information, such as e-mail addresses, may be provided so that the individuals may be contacted as needed to carry out the various functions of payment manager 20, such as transaction reconciliation.

FIG. 9b illustrates an enrollment form 246 for entering account set-up information. Form 246 may receive information similar to that received by form 240. In particular, form 246 may receive account information 248 that identifies a user's account status, such as ACH account status and routing numbers. Form section 250 may provide a list of vendors from which a user can select vendors who may be paid from the account.

FIG. 9c illustrates an enrollment form 252 for entering role information for individuals within a payor or payee company. Role definition 254 may receive information regarding the authority that the individual has with respect to payments, such as the type of payments (e.g., direct or indirect) allowed and the maximum amount of payment allowed. Functional capabilities section 256 may receive information regarding other powers that the individual may have, such as approval authority.

FIG. 9d illustrates an enrollment form 258 for entering information about an individual within a payor or payee company. Form 258 may be an extension of form 252, and may receive information identifying the individual, such as the individual's name, address, supervisor name, and contact information. In addition, form 258 may receive a “role association” for the individual. A particular role, with identified rights and responsibilities, may have been set up earlier, and by associating the individual with that role, the rights and responsibilities may be assigned to the individual easily. In addition, the rights and responsibilities may be changed for a single role, and then changed automatically for all individuals who share that role. For example, all purchasing managers at a particular level within a given organization may be assigned the same responsibilities and rights.

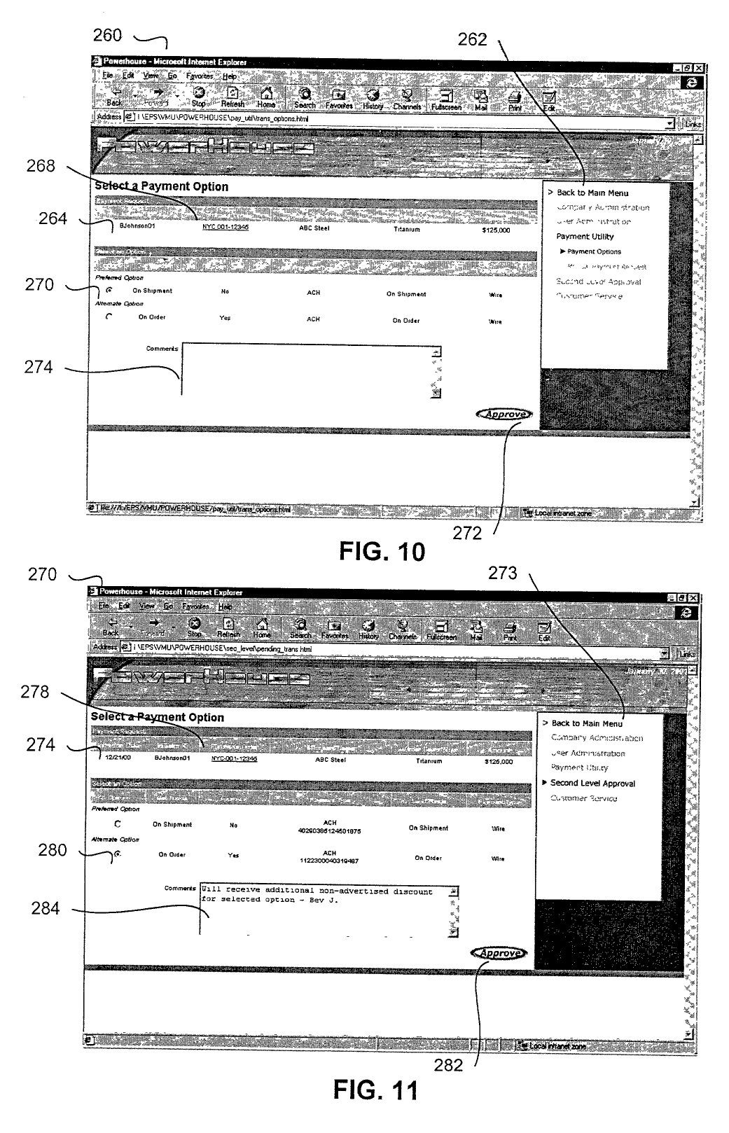

FIG. 10 illustrates a sample payment transaction form 260. Form 260 may be customized for a particular individual and contain information about the user profile 264, including contact information and authorization limits for the individual. Form 260 may also include a summary 266 of previous transactions, including the date of the transaction, the product or process involved in the transaction, the seller, a transaction identification number, the amount of the transaction, and the order and payment status. Detailed information on the current transaction 268 may also be shown, including the amount of the transaction with line items, the seller, the delivery method, the expected delivery time and sales terms, and payment timing information. A payment summary 270 may provide information about the payment method for the current transaction, including a recommendation regarding the best available payment method. An approval request 272 may also be provided so that the individual, if he or she lack approval status, can select an approver from a list of available approvers and provide comments for the transaction 274 that will be made available to the approver during the approval process. Finally, navigation control 262 may be provided to allow the individual to move to other areas of the payment manager.

FIG. 11 illustrates a sample payment approval form 270. Form 270 may be customized for a particular individual user or organization and contain information about the originating requester 274, including contact information and authorization limits for the requester. Detailed information on the current transaction 278 may also be shown, including the amount of the transaction with line items, the seller, the delivery method, the expected delivery time and sales terms, and payment timing information. A payment method recommendation 280 may provide information about the payment method for the current transaction, including a recommendation regarding the best available payment method and other payment methods that meet the user's payment rules. An approval request 282 may also be provided so that the individual may accept the chosen payment method and begin execution of the transaction or continue the routing of workflow to reach full approval of the payment transaction. Additional instructions or comments 284 may be added to the transaction to assist subsequent approvers information pertinent to the transaction and payment method selection. Finally, navigation controls 282 may be provided to allow the individual to move to other areas of the payment manager.

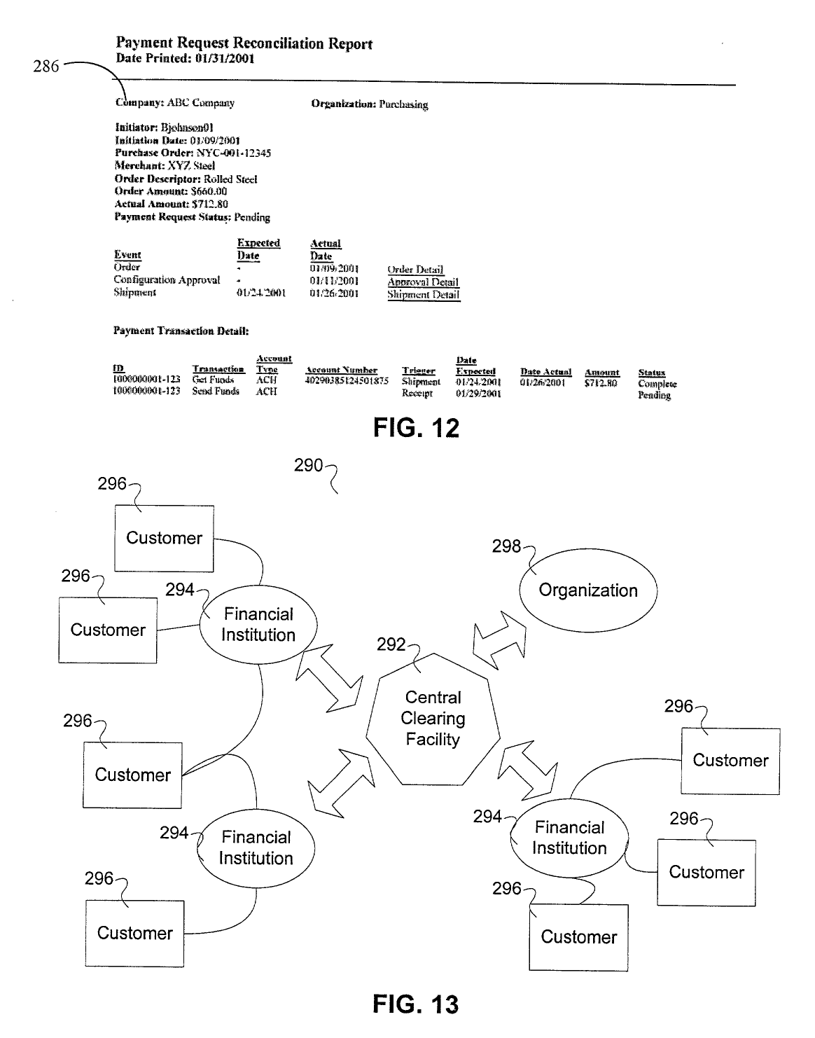

FIG. 12 illustrates a sample reconciliation report. This report may detail the original payment request, the selected payment transaction and the subsequent event history of the payment transaction. Historical events may include shipping and receiving data that indicate any discrepancies between the agreed transaction and actual events, expected and actual timings of the payment triggers, and expected and actual dollar amounts retrieved and sent to the payor and payee. Additionally, any dispute events may be included in the reconciliation report.

FIG. 13 is a block diagram illustrating the relationship between and among participants in a funds settlement system 290. Settlement system 290 may be comprised of a central payment facility 292 that interacts with a plurality of financial institutions 294, all of which may be configured to communicate using a common data format, such as that described above. The data format may include information about transactions, including information regarding timing of payments (or triggers for payment) and methods of payment. Using the data format, central payment facility 292 may receive electronic transaction information from financial institutions, and may track payments made by customers 296 of financial institutions. Large organizations 298 may also communicate with central payment facility 292 in a similar manner to financial institutions 294. In addition, a customer 296 may be a customer of more than one financial institution 294.

Traditional settlement of transactions between and among financial institutions can be expensive. Many transactions between two financial institutions occur through a clearinghouse settlement, such as that maintained by the Federal Reserve Bank or Visa®. Generally, however, each clearinghouse supports only limited payment types or methods. For example, the Federal Reserve Bank is the primary clearinghouse for checks and wire transfers, while Visa®, MasterCard®, and American Express® are examples of credit card clearinghouses. Alternatively, some financial institutions clear transactions directly with other institutions, for example by the exchange of cash-letters, but this method can increase costs in ensuring compatibilities, in transportation, and in reconciliation costs. The least expensive method for clearing a transaction is “on us” settlement, whereby a payor and payee are customers of the same financial institution, so that a transaction may be cleared with a simple debit and credit.

The transaction information discussed above may allow central payment facility 292 to decrease the number of transactions between and among financial institutions 294 and organizations 298, and thereby decrease the cost of the transactions. In particular, central payment facility 292 may access information about transactions performed through central payment facility 292. In particular, central payment facility 292 may access information regarding the financial institutions of which a payor or and a payee are members or may access information from which the financial institutions may be computed, and may pass information regarding the transaction to the respective financial institutions.

The information maintained by central payment facility 292 may be used to settle accounts. Central payment facility 292 may keep a running total or may calculate a total of transactions made between various financial institutions, and may hold payment on those transactions until the expiration of a set period of time or until a particular event occurs. For example, accounts could be netted out and settled every two hours or once a day, for example in the middle of the night. In addition, a financial institution 294 or other organization 298 could send a payment settlement request to central payment facility 292 requesting that all of its outstanding accounts be settled immediately, upon the happening of a set event, or at a set time. Alternatively, the payment settlement request could be sent by a person or other entity other than the particular financial institution 294 or other organization 298. Central payment facility 292 may then execute payments for the net outstanding amounts to each financial institution or other organization. Central payment facility 292 may maintain clearing accounts for financial institutions 294 and may debit or credit accounts accordingly, or may execute payments through other payment clearinghouses. In either manner, the cost of executing payments may be reduced because the volume of executed transactions may be significantly reduced. In particular, the more a financial institution 294 or other organization uses central payment facility 292, the more it could consolidate payment execution, and it could thereby save more on transaction expenses. In addition, savings both in transaction costs and administrative cost could be realized because fewer clearinghouses would need to be used.

In addition to settling outstanding balances for financial institutions 294 and other organizations 298, central payment facility 292 may pass detailed financial information to financial institutions 294 and other organizations 298. In this manner, central payment facility 292 may provide financial institutions 294 and other organizations 298 with transaction details needed to support the reconciliation of individual transactions and for auditing purposes. For example, central payment facility 292 could supply account numbers of parties to a transaction, transaction amounts, information or images regarding a payment item (such as a check), or other information. This information may be used by financial institutions 294 and other organizations 298 to supplement other transaction information provided to financial institutions 294 and other organizations 298, for example, at the time of the transaction.

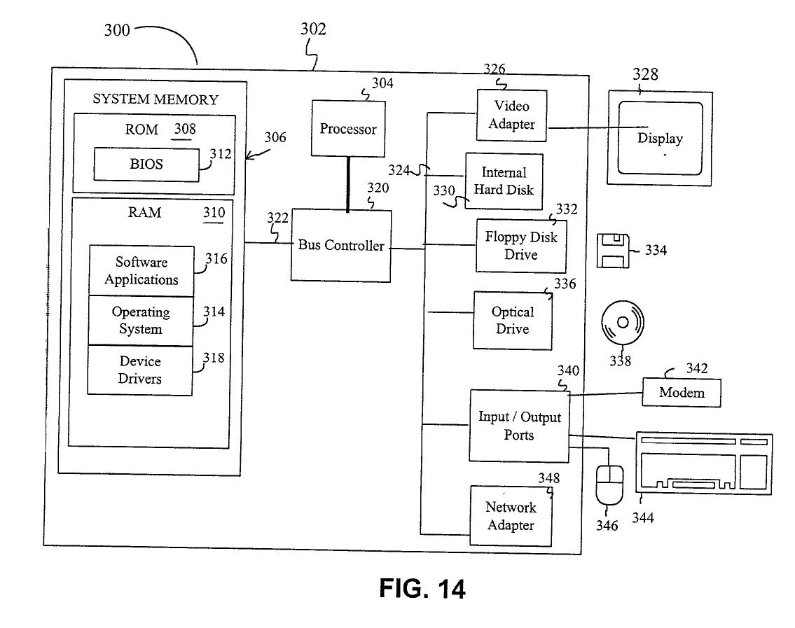

FIG. 14 illustrates a programmable computing system 300 that provides an operating environment suitable for implementing the techniques described above, either as a central payment facility or as a remote terminal. The system 300 includes a computer 302 that contains a processor 304 connected to system memory 306 through bus controller 320 and system data/address bus322. Memory 306 includes read only memory (ROM) 308, which may include BIOS 312 or other components, and random access memory (RAM) 310, which may be used to store an operating system 314, software applications 316, and various device drivers 318. In one embodiment, however, software applications 316 are stored in ROM 308 and are copied to RAM 310 for execution, or are executed directly from ROM 308. In various configurations, system 300 represents any server, personal computer, laptop or even a battery-powered, pocket-sized, mobile computer known as a hand-held PC or personal digital assistant (PDA). System 300 could also represent a variety of processors, communications devices, and storage devices tied together in a network, included a local area network (LAN), a wide area network (WAN), a virtual private network (Intranet), or the Internet.

Bus controller 320 may connect to other devices through input/output bus 324. For example input/output bus 324 may support a video adapter 326 connected to display 328 (or multiple displays) to provide visual output for system 300. Bus controller 320 may also support any of a number of input or storage devices, such as internal hard disk 330, floppy disk drive 332, which accepts floppy disk 334, and optical drive 336, which accepts optical disk 338. Other devices, such as modem 342, keyboard 344, and mouse 346, may be connected to input/output bus 324 through input/output ports 340. Other types of input devices (not shown) include track pads, track balls, joysticks, data gloves, head trackers, and other devices suitable for positioning a cursor on the video display 328, or for otherwise providing directions to system 300. In addition, network adapter 348 may be provided to give system 300 access to external resources, such as a LAN, WAN, VPN, or the Internet.

A number of embodiments of the invention have been described. Nevertheless, it will be understood that various modifications may be made without departing from the spirit and scope of the invention. For example, as noted, the invention is not limited to Internet-based payment methods or systems, or to payments only between or among businesses or organizations. Also, although users of the payment manager have been described above as either payors or payees, a particular user could be a payor or a payee depending on the context, and could be a payor and a payee in the same transaction, for example, if a rebate is provided with a purchase. In addition, the steps described do not have to be performed in every situation, and the steps could be performed out of order or interleaved. This application is intended to cover any adaptation or variation of the present invention. It is intended that this invention be limited only by the claims and equivalents thereof. Accordingly, other embodiments are within the scope of the following claims.

What is claimed is:

1. A method of executing a payment transaction from a payor to a payee, comprising the steps of:
receiving a payment authorization request;
creating a get funds trigger that carries information for selecting a method of making payment;
creating a get funds type that carries information for selecting a method of receiving payment;
creating an approval that carries information for determining the approval status of the payment;
creating a send funds trigger that carries information for executing a transmittal of funds;
creating a send funds type that carries information for selecting a method of receiving payment;
transmitting the get funds trigger, get funds type, approval, send funds trigger, and send funds type in a single message; and
executing payment from the payor using a payment method corresponding to the get funds type, and executing payment to the payee using a payment method corresponding to the send funds type.

2. The method of claim 1, further comprising assigning a value to at least one of the get funds trigger, the get funds type, the send funds trigger, or the send funds type.

3. The method of claim 2, wherein the assigned value is an integer value.

4. The method of claim 1, further comprising assigning a value to the get funds trigger and assigning a value to the get funds type.

5. The method of claim 1, further comprising assigning a value to the send funds trigger and assigning a value to the send funds type.

6. The method of claim 1, further comprising transmitting a data layer as part of the single message, the data layer comprising information that describes parameters of a commercial transaction corresponding to the payment transaction.

7. The method of claim 6, wherein the data layer comprises shipping information.

8. The method of claim 6, wherein the data layer comprises information from an e-commerce communication protocol.

9. The method of claim 8, wherein the data layer comprises information that is a superset of information from xCBL and cXML.

10. A method of executing a payment from a payor intended for a payee, comprising the steps of:
creating a get funds trigger that carries information for selecting a method of making payment;
creating a get funds type that carries information for selecting a method of receiving payment;
creating an approval that carries information for determining the approval status of the payment;
creating a send funds trigger that carries information for executing a transmittal of funds;
creating a send funds type that carries information for selecting a method of receiving payment; and
transmitting the get funds trigger, get funds type, approval, send funds trigger, and send funds type in a single message.

11. The method of claim 10, further comprising assigning a value to at least one of the get funds trigger, the get funds type, the send funds trigger, or the send funds type.

12. The method of claim 11, further comprising assigning a value to the get fluids trigger and assigning a value to the get funds type.

13. The method of claim 10, further comprising transmitting a data layer as part of the single message, the data layer comprising information that describes parameters of a commercial transaction corresponding to the payment transaction.

14. A method of executing a payment to a payee from a payor, comprising the steps of:
receiving in a single message a get fluids trigger that carries information for selecting a method of making payment, a get funds type that carries information for selecting a method of receiving payment, a send funds trigger that carries information for executing a transmittal of funds, and a send funds type that carries information for selecting a method of receiving payment; and
executing payment to the payee by a method corresponding to a value of the send funds type.

15. The method of claim 14, further comprising receiving a data layer as part of the single message, the data layer comprising information that describes parameters of a commercial transaction corresponding to the payment transaction.

16. A data communication structure for transmitting payment information about a payment transaction, comprising:
a get funds trigger entry that carries information for executing a retrieval of funds;
a get fluids type entry that carries information for selecting a method of making payment;
an approval entry that carries information for determining the approval status of the payment;
a send funds trigger entry that carries information for executing a transmittal of funds; and
a send funds type entry that carries information for selecting a method of receiving payment.

17. The data communication structure of claim 16, further comprising a data layer that carries information describing parameters of a commercial transaction corresponding to the payment transaction.

18. The data communication structure of claim 17, wherein the data layer carries information that is a superset of information from xCBL, and cXML.

19. A payment execution system for carrying out a payment transaction from a payor to a payee, comprising:
a payment execution computer;
a plurality of remote payment nodes corresponding to a plurality of remote users, the remote payment nodes enabling the remote users to submit transaction data to the system; and
a communications network;
wherein the payment execution computer is coupled to the plurality of remote payment nodes by the communications network, and transmits a payment message comprising a get funds type entry, a get funds trigger entry, an approval entry, a send funds trigger entry, and a send funds type entry.

20. A propagated signal for transmitting payment information about a payment transaction, comprising:
a get funds trigger entry that transmits information for executing a retrieval of funds;
a get funds type entry that transmits information for selecting a method of making payment;
an approval entry that transmits information for determining the approval status of the payment;
a send funds trigger entry that transmits information for executing a transmittal of funds; and
a send funds type entry that transmits information for selecting a method of receiving payment.

21. The signal of claim 20, further comprising a data layer comprising information that describes parameters of a commercial transaction corresponding to the payment transaction.

22. The signal of claim 21, wherein the data layer comprises information from an e-commerce communications protocol.
